(19) United States
(12) Patent Application Publication
(10) Pub. No.: US 2025/0181230 A1
(43) Pub. Date: Jun. 5, 2025

(54) MODULAR ARTIFICIAL INTELLIGENCE (AI) CONFIGURATION

(71) Applicant: hal9, Inc., Carnation, WA (US)

(72) Inventor: Javier Arturo Porras LURASCHI, Carnation, WA (US)

(21) Appl. No.: 18/226,869

(22) Filed: Jul. 27, 2023

Related U.S. Application Data
(63) Continuation of application No. PCT/US22/13486, filed on Jan. 24, 2022.
(60) Provisional application No. 63/142,330, filed on Jan. 27, 2021.

(51) Int. Cl. G06F 3/04847; G06F 3/0482

(52) U.S. Cl. CPC G06F 3/04847; G06F 3/0482

(57) ABSTRACT

Technologies and implementations for a modular machine learning system including an artificial intelligence configuration module (AICM). The AICM may be configured to provide a modular process via a user interface to facilitate machine learning.

### RELATED APPLICATION

This application claims benefit of priority to U.S. Provisional Patent Application Ser. No. 63/142,330, filed on Jan. 27, 2021, titled MODULAR ARTIFICIAL INTELLIGENCE, which is incorporated herein by reference in its entirety for all purposes.

### INFORMATION

Unless otherwise indicated herein, the approaches described in this section are not prior art to the claims in this application and are not admitted to be prior art by inclusion in this section.

Artificial Intelligence (AI), which may include technology related to machine learning and/or deep learning, may have a variety of applications. Al may utilize a variety of methodologies such as, but not limited to, mathematics, statistics, computer science, data science, distributed systems, and so forth. As one may appreciate, in order to facilitate utilization of the variety of methodologies, programing machines (i.e., programming a machine to learn) to function as an Al machine may be difficult and/or complicated. Additionally, similar applications of Al may include a wide variety of approaches and modules. Accordingly, similar applications of Al may include different programming approaches and modules, which may result in inconsistencies and repeatability issues.

All subject matter discussed in this section of this document is not necessarily prior art and may not be presumed to be prior art simply because it is presented in this section. Plus, any reference to any prior art in this description is not and should not be taken as an acknowledgement or any form of suggestion that such prior art forms parts of the common general knowledge in any art in any country. Along these lines, any recognition of problems in the prior art are discussed in this section or associated with such subject matter should not be treated as prior art, unless expressly stated to be prior art. Rather, the discussion of any subject matter in this section should be treated as part of the approach taken towards the particular problem by the inventor(s). This approach in and of itself may also be inventive. Accordingly, the foregoing summary is illustrative only and not intended to be in any way limiting. In addition to the illustrative aspects, embodiments, and features described above, further aspects, embodiments, and features will become apparent by reference to the drawings and the following detailed description.

### SUMMARY

Described herein are various illustrative systems and methods for modular configuration of a machine learning. Example systems may include a processor and a storage medium, where the storage medium communicatively coupled to the processor. Example systems may include an artificial intelligence configuration module (AICM) communicatively coupled to the storage medium and to the processor. Example systems may include the AICM configured to receive an indication of selection of a first module, where the first module being selectable from a first category. Example system may include the AICM configured to receive an indication of selection of a second module, where the second module being selectable from a second category. Example system may include the AICM configured to integrate the first module and the second module based upon the first category and the second category and form a pipeline having the integrated first module and the second module, where the pipeline being modifiable responsive to changes to the first module and the second module included in the pipeline and configured to learn trends and predictions based upon the integrated first module and the second module. Example system may include the AICM configured to receive a selection of one of the first module or the second module included in the pipeline and receive an input to modify code of the selected module. Example system may include the AICM configured to responsive to the received input, cause a modification of a functionality of the selected module resulting in a modified module, where the modified module being a different version of the selected module included in the pipeline. Example system may include the AICM configured to and cause a modification of the learned trends and predictions based upon the modified module.

The foregoing summary is illustrative only and not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 illustrates a block diagram of a system for modular configuration of machine learning in accordance with various embodiments.

FIG. 2 illustrates an interface in accordance with various embodiments.

FIG. 3 illustrates an interface configured to display categories and modules in accordance with various embodiments.

FIG. 4 illustrates an interface configured to display a first module in accordance with various embodiments.

FIG. 5 illustrates selection of a second module from a second category in accordance with various embodiments.

FIG. 6 illustrates an interface configured to display a second module in accordance with various embodiments.

FIG. 7 illustrates selection of a third module from a third category in accordance with various embodiments.

FIG. 8 illustrates an interface configured to display a third module in accordance with various embodiments.

FIG. 9 illustrates selection of a fourth module from a fourth category in accordance with various embodiments.

FIG. 10 illustrates an interface configured to display a third module in accordance with various embodiments.

FIG. 11 illustrates code corresponding to one or more modules in accordance with various embodiments.

FIG. 12 illustrates edited code in accordance with various embodiments.

FIG. 13 illustrates an example of an interface in accordance with some alternate embodiments.

FIG. 14 illustrates an operational flow a modular AI process provided via a user interface to facilitate machine learning in accordance with various embodiments as described herein.

FIG. 15 illustrates an example computer program product, arranged in accordance with at least some embodiments described herein.

FIG. 16 is a block diagram illustrating an example computing device, such as might be embodied by a person skilled in the art, which is arranged in accordance with at least some embodiments of the present disclosure.

### DETAILED DESCRIPTION

The following description sets forth various examples along with specific details to provide a thorough understanding of claimed subject matter. It will be understood by those skilled in the art after review and understanding of the present disclosure, however, that claimed subject matter may be practiced without some or more of the specific details disclosed herein. Further, in some circumstances, well-known methods, procedures, systems, components and/or circuits have not been described in detail in order to avoid unnecessarily obscuring claimed subject matter.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to methods, apparatus, and systems for modular configuration of artificial intelligence (AI). The modular configuration of Al may facilitate of machine learning of trends and predictions. The modular configuration may facilitate real-time modifications and adjustments to machine learning such as, but not limited to, the learned trends and predictions.

Before turning to the figures, a non-limiting example scenario of utilization of the various embodiments of a modular artificial intelligence (AI) configuration may be described. In the non-limiting example scenario, utilization of a machine to learn various trends and predictions based upon various data may be facilitated. In this example, a user may select a first module. The selection may be facilitated by a graphical user interface (GUI) having a first portion to facilitate the selection of the first module via a mouse selection on a “+” sign (e.g., mouse click). When the user selects the operation to add a first module (i.e., mouse select the + sign), the GUI may display one or more categories having various modules.

In one example, the categories that may be displayed may include “Datasets”, “Import”, “Transforms”, “Visualize”, “Predict”, and “Export”. In this example scenario, the user may select “CSV” module from the Import category. The selection may be via a mouse selection. The CSV module may include functionality to import a CSV formatted dataset. When the CSV module is selected, the module may be displayed on the first portion of the GUI proximate to the + sign.

Subsequently, the user may select to add another module (e.g., mouse select the + sign), and responsive to the action of the user, the GUI may display the one or more categories having the various modules. The user may select a module from the Transforms category. Continuing with this example scenario, the user may select the “Sample” module from the Transforms category. The Sample module may be configured to include the functionality of trimming a dataset down to a random sample of its rows. When the Sample module is selected, the module may be displayed on the first portion of the GUI.

The first portion of the GUI having the selected first module, the second module, and the +sign may be referred to as a “Pipeline”. The Pipeline may be one or more modules displayed as a sequential order. The first module and the second module may be integrated based upon the categories (i.e., data and treatment of the data). As will be described in more detail, since each of the modules in the Pipeline may be removed or modified, the Pipeline, itself, may be modified.

Continuing with the example scenario, in addition to the two selected modules (i.e., CSV and Sample), the user may add another module. For example, the user may select the “Line” module from the Visualize category. The Line module may be configured to facilitate visualization of the integration of the first two modules (i.e., data and the treatment of the data), which may be shown as a line graph for use with sorted X axis values of the treated data. When the Line module is selected, the module may be displayed on the first portion of the GUI as a third module in the Pipeline. The result of integrating the Line module with the CSV module and the Sample module in the Pipeline may be displayed on a second portion of the GUI as a line graph.

As part of machine learning, an additional module may be selected to facilitate Al. For example, the user may select to add a module from the Predict category. As previously described, the user may select to add the additional module by selecting the + sign on the first portion of the GUI. The module selected from the Predict category may be “Regression” module. The Regression module may be configured to fit a regression model to a dataset to predict future values. When the Regression module is selected, the module may be displayed on the first portion of the GUI as part of the Pipeline. Additionally, the integration of the Regression module in the Pipeline may be displayed on the second portion as part of the module from the Visualize category (i.e., the Line module). For example, the line graph shown in the second portion of the GUI may include some form of graphical representation of the Regression module such as, but not limited to, a line. The line may illustrate the future prediction as learned trends and predictions of machine learning from the datasets as modularly integrated in the Pipeline shown in the first portion of the GUI.

In one example, on a third portion of the GUI, a number of graphical parameters corresponding to the one or more modules in the Pipeline may be displayed. The number of graphical parameters may be configured to facilitate adjustment of the modules in the Pipeline. For example, one or more axes (e.g., x axis and/or y axis) of the Line module may be adjusted and/or modified by dropdown menus, mouse selection, etc. Adjustments and/or modifications of the parameters of the Line module may be reflected in real-time on the second portion of the GUI displaying the line graph including any effects on the Regression module (i.e., changes in trends and predictions).

In another example, on a fourth portion of the GUI, code may be displayed. The code may be code corresponding to the modules in the Pipeline and may be editable. For example, continuing with the non-limiting example scenario, the code for the Line module may include lines of code corresponding to the x axis and the y axis utilized for generating the Line graph and displayed on the second portion of the GUI. The user may edit lines of code to include a z axis. Responsive to the editing of the code to add the z axis to the Line module, the graphical parameters corresponding to the Line module displayed on the third portion of the GUI may now include a z axis. Additionally, the line graph displayed on the second portion of the GUI may change in real-time to reflect the processing of the addition of the z axis on the line graph including any effects on the Regression module (i.e., changes in trends and predictions) caused by the addition of the z axis.

As a result, a modular process may be provided via a GUI to facilitate machine learning. The modules, its parameters, and its underlying code may all be selectable, modifiable, editable, etc., where the changes may be processed and displayed in real-time.

It should be appreciated that the above non-limiting example scenario may include a wide variety of collection of data and may be from a variety of sources such as, but not limited to, an application, a cloud service, a social network, a marketplace of modules, source control systems, a local file system, etc. The data may be selected and/or imported from various data such as, but not limited to, comma separated values (CSV), social network (e.g., Twitter), Excel (XLS), JSON, images (.png, jpg, .pdf, etc.) and so forth. Accordingly, the claimed subject matter is not limited in this respect.

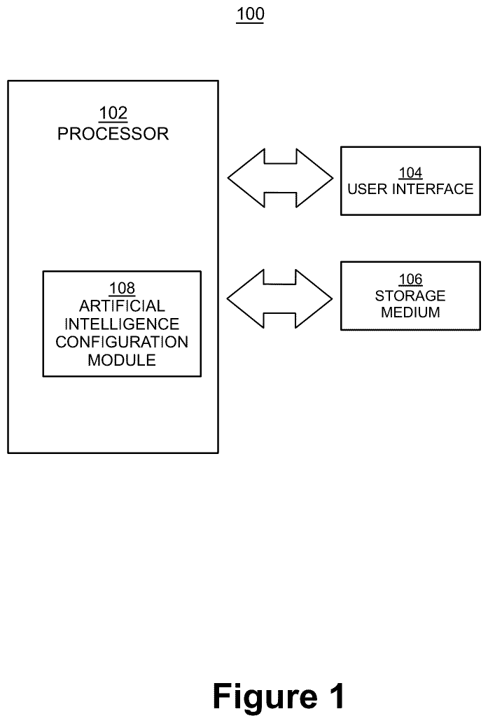

The above non-limiting example scenario may include a wide variety of visualizations such as, but not limited to, bar charts, bubble charts, scatter charts, heat maps, etc. Accordingly, the claimed subject matter is not limited in this respect. Turning now to FIG. 1, FIG. 1 illustrates a block diagram of a system for modular configuration of machine learning in accordance with various embodiments. In FIG. 1, a system 100 may include a processor 102, a user interface 104, and a storage medium 106. Additionally, the processor 102 may include an artificial intelligence configuration module (hereon, AICM 108). As shown, the AICM 108 may be communicatively coupled to the user interface 104 and to the storage medium 106.

In FIG. 1, the user interface 104 may be configured to cause to display a user interface to facilitate interaction with a user (not shown) such as, but not limited to, a graphical user interface (GUI) as described in the various embodiments disclosed herein. The storage medium 106 may store various categories and modules to be utilized by the AICM 108.

In FIG. 1 and as described in the example scenario, the AICM 108 may be configured to receive an indication of a selection of a first module, where the first module may be selectable from a first category. The selection of the first module may be facilitated by the user interface 104. Additionally, the AICM 108 may be configured to receive an indication of selection of a second module, where the second module may be selectable from a second category. The AICM 108 may be configured to integrate the first module and the second module based upon the first category and the second category. A pipeline may be formed having the integrated first module and the second module, where the pipeline may be modifiable responsive to changes to the first module and the second module included in the pipeline and configured to learn trends and predictions based upon the integrated first module and the second module. The pipeline and/or the modules may be displayed and interactable by the user via the user interface 104. The AICM 108 may be configured to receive a selection of one of the first module or the second module included in the pipeline. The selection may be facilitated by the user interface 104. An input to modify code of the selected module may be received by the AICM 108. Responsive to the received input, the AICM 108 may be configured to cause a modification of a functionality of the selected module resulting in a modified module, where the modified module may be a different version of the selected module included in the pipeline as may be displayed on the user interface 104. The code may be displayed on the user interface 104 as well. Based upon the modified module, the learned trends and predictions may be modified. As a result, a modular process may be provided via a user interface to facilitate machine learning in accordance with various embodiments.

In FIG. 1, the user interface 104 may include a wide variety of user interfaces such as, but not limited to graphical user interface (GUI), virtual reality user interface, text interface, audio interface, and so forth in accordance with various embodiments. Accordingly, even though some disclosure may be described utilizing a display as a GUI, it contemplated that the interface may be a wide variety of interfaces having some of the functionality described herein.

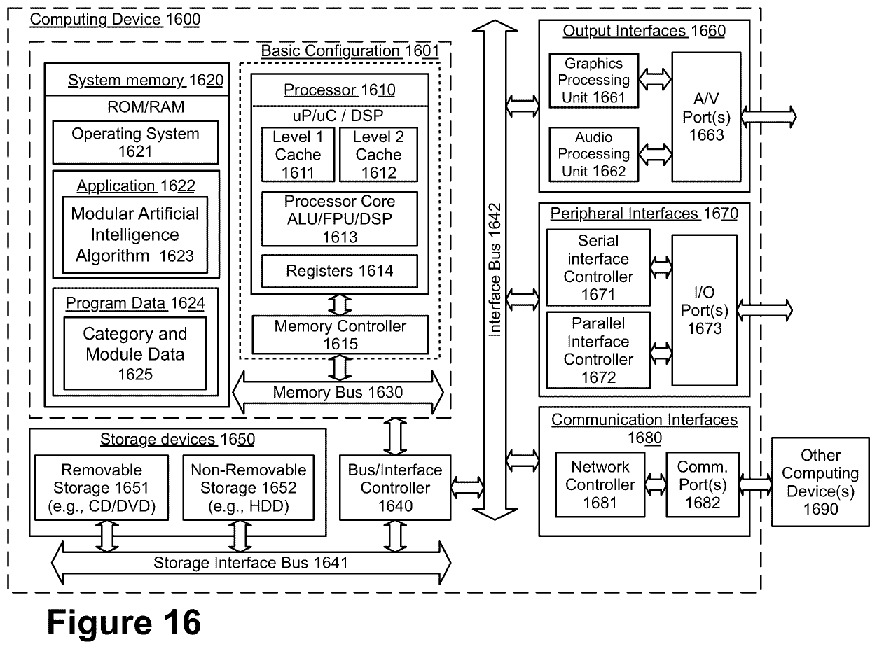

In various embodiments, the system 100 may be included in a wide variety of computer systems such as, but not limited to, artificial intelligence (AI) computer systems, machine learning systems, ubiquitous machine systems, mobile computing systems, handheld computing systems, virtual computing systems, internet based machines, and so forth. Additionally, in various embodiments, the system 100 may be applicable to a wide variety of machine environments such as, but not limited to, social networking environments, financial environments, virtual reality environments, enterprise environments, video networking environments, audio networking environments, and so forth. Some further details of the system 100 may be found with respect FIG. 16.

In FIG. 1, the processor 102 may be a wide variety of processors to facilitate at least some of the functionality described herein such as, but not limited to, machine learning capable processors. Some of examples of machine learning capable processors may include processors available from Intel Corporation of Santa Clara, California (e.g., Nervana™ type processors), available from Nvidia Corporation of Santa Clara, California (e.g., Volta™ type processors), available from Apple Company of Cupertino, California (e.g., A11 Bionic™ type processors), available from Huawei Technologies Company of Shenzen, Guangdong, China (e.g., Kirin™ type processors), available from Advanced Micro Devices, Inc. of Sunnyvale, California (e.g., Radeon Instinct™ type processors), available from Samsung of Seoul, South Korea (e.g., Exynos™ type processors), and so forth. Accordingly, the claimed subject matter is not limited in this respect.

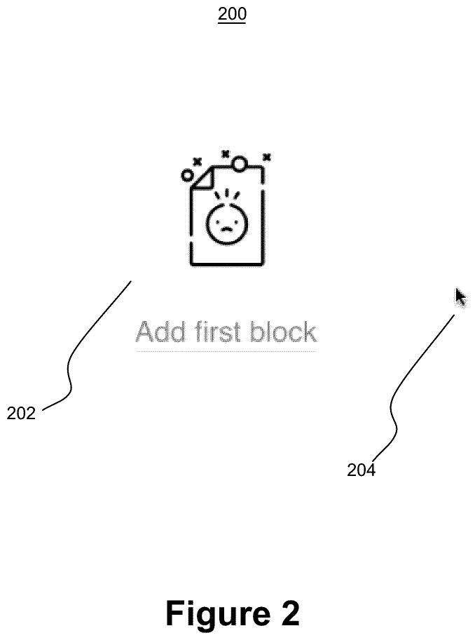

FIG. 2 illustrates an interface in accordance with various embodiments. In FIG. 2, an interface 200 may include a selectable section 202 to add a first module (e.g., “Add first block”). Additionally, the interface 200 may include a mouse pointer 204 to facilitate interaction with the interface 200. The interface 200 may be included as part of a portal via the internet or as part of an interface included in a personal device.

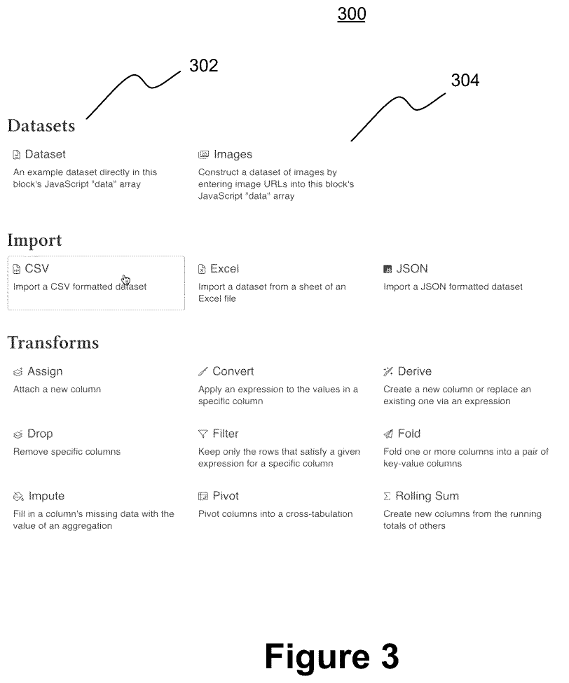

FIG. 3 illustrates an interface configured to display categories and modules in accordance with various embodiments. In FIG. 3, an interface 300 may be displayed subsequent to the selection of the selectable section 202 in FIG. 2. The interface 300, may include a number of categories 302. Each of the categories 302 may include a number of modules. In FIG. 3, the user may be shown to select a CSV module 304 included in an Import category 302. The CSV module 302 may be configured to facilitate import of a comma separated values formatted dataset.

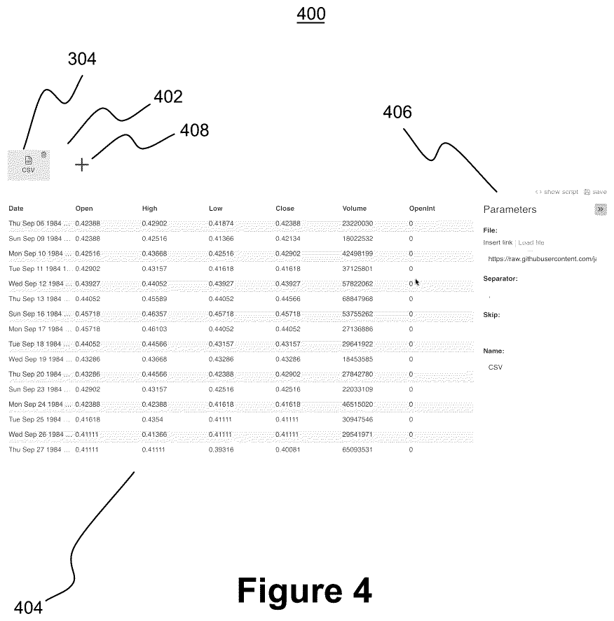

FIG. 4 illustrates an interface configured to display a first module in accordance with various embodiments. In FIG. 4, an interface 400 may be displayed subsequent to the selection of the CSV module 304 in FIG. 3. The interface 400 may include a first portion 402. In FIG. 4, the first portion 402 may be configured to receive the selection of a module (e.g., the CSV module 304). The first portion 402 having the CVS module 304 may be referred to as pipeline 402. Illustrated in FIG. 4, the interface 400 may include a second portion 404 configured to display learned trends and predictions and may be referred to as visual result 404. Additionally, the interface 400 may include a third portion 406 configured to display one or more parameters corresponding to the one or more modules in the pipeline 402 and may be referred to as parameter 406.

As shown in FIG. 4, the pipeline 402 may include the first module (e.g., CSV module 304) without additional modules. Accordingly, the parameter 406 may correspond to the single module (e.g., CSV module 304) in the pipeline 402, and the visual result 404 may display a dataset corresponding to the single module (e.g., CSV module 304) in the pipeline 402.

In FIG. 4, selection of additional modules may be facilitated by a mouse selectable + sign 408, which may be included in the pipeline 402. Selection of the + sign 408 may cause the interface having the categories and modules (e.g., interface 300) may be displayed to facilitate selection of additional modules.

It should be appreciated that interface 400 shown in FIG. 4 may illustrate but one example of an interface. For example, a layout of the interface 400 may be in a wide variety of manners such as, but not limited to, vertical pipeline, diagonal pipeline, one or more additional portions configured to display additional parameters, alternative symbols for various parameters and/or the + sign, different languages, and so forth. Accordingly, the claimed subject matter is not limited in these respects.

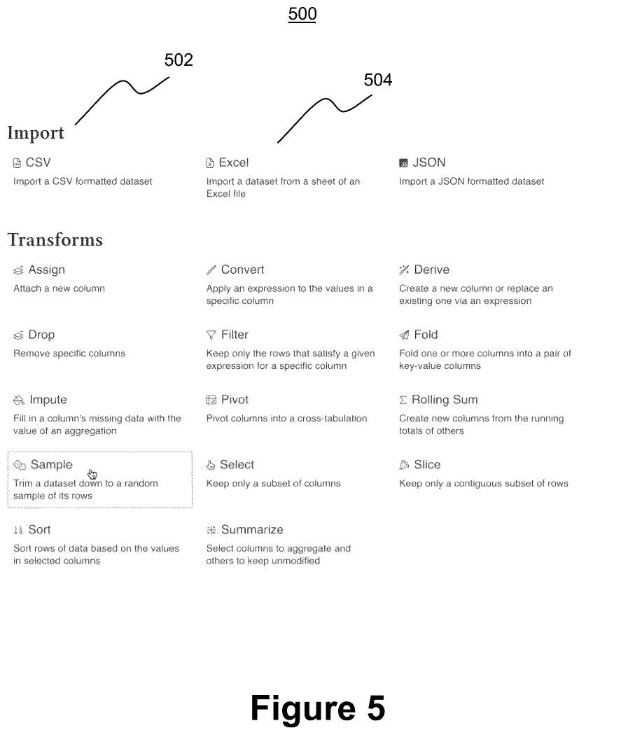

FIG. 5 illustrates selection of a second module from a second category in accordance with various embodiments. In FIG. 5, an interface 500 may be caused to be displayed responsive to the indication of a selection of the + sign 408 shown in FIG. 4. The interface 500 may be similar to the interface 300 shown in FIG. 3. Accordingly, the interface 500 may include a number of categories 502 and a number of modules 504. Shown in FIG. 5, a module from a Transform category may be selected. As shown, a Sample module 504 may be selected. The Sample module 504 may be configured to trim a dataset down to a random sample of its rows.

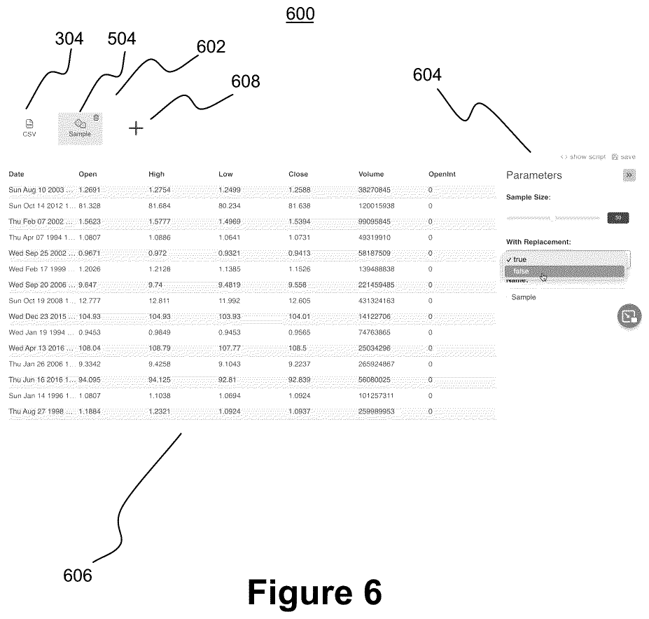

FIG. 6 illustrates an interface configured to display a second module in accordance with various embodiments. In FIG. 6, an interface 600 may be displayed subsequent to the selection of the Sample module 504 in FIG. 5. Similar to the interface 400 shown in FIG. 4, the interface 600 may include a pipeline 602, a parameter 604, a visual result 606, and a + sign 608.

In FIG. 6, the interface 600 may include the pipeline 602 displaying the first module (e.g., CSV module 304) and the selected second module (e.g., Sample module 504). Additionally, the interface 600 may include the parameter 604 displaying additional modifiable parameters corresponding to the modules in the pipeline (e.g., CSV module 304 and Sample module 504). For example, the parameter 604 may display various parameters that may correspond to parameters for each of the modules in the pipeline 602. As shown in FIG. 6, the visual result 606 may display datasets because the selected modules may be related to datasets.

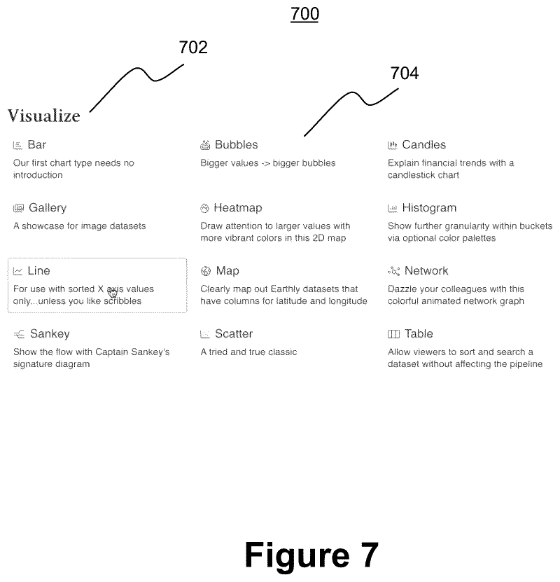

FIG. 7 illustrates selection of a third module from a third category in accordance with various embodiments. In FIG. 7, an interface 700 may be caused to be displayed responsive to the indication of a selection of the + sign 608 shown in FIG. 6. The interface 700 may be similar to the interface 300 shown in FIG. 3 and interface 500 shown in FIG. 5. Accordingly, the interface 700 may include a category 702 and a number of modules 704. Shown in FIG. 7, a module from a Visualize category may be selected. As shown, a Line module 704 may be selected. The Line module 704 may be configured to be for use with sorted X axis values . . . unless you like scribbles.

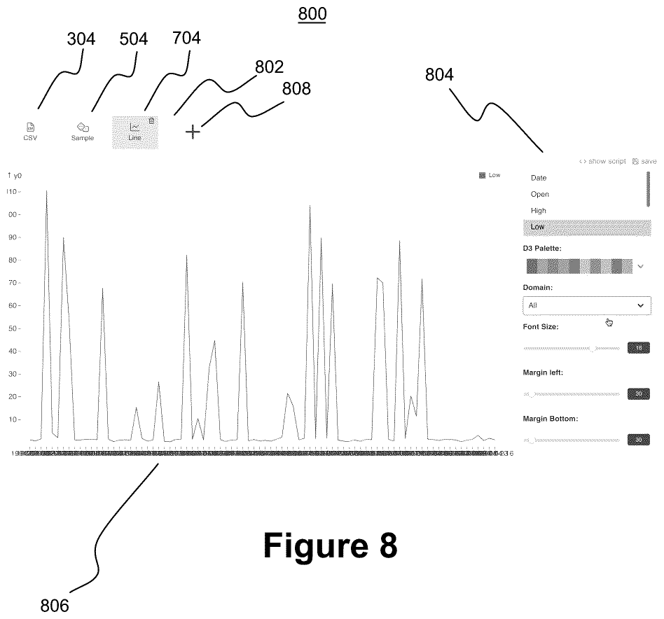

FIG. 8 illustrates an interface configured to display a third module in accordance with various embodiments. In FIG. 8, an interface 800 may be displayed subsequent to the selection of the Line module 704 in FIG. 7. Similar to the interface 400 shown in FIG. 4 and interface 600 shown in FIG. 6, the interface 800 may include a pipeline 802, a parameter 804, a visual result 806, and a + sign 808.

In FIG. 8, the interface 800 may include the pipeline 802 displaying the first module (e.g., CSV module 304), the selected second module (e.g., Sample module 504), and the third module (e.g., Line module 704). Additionally, the interface 800 may include the parameter 804 displaying additional modifiable parameters corresponding to the modules in the pipeline (e.g., CSV module 304, Sample module 504, and Line module 704). For example, the parameter 804 may display various parameters that may correspond to parameters for each of the modules in the pipeline 802. As shown in FIG. 8, the visual result 806 may display a line graph because the selected modules may be related to datasets which may be integrated to be visualized as a line graph (e.g., selected Line module 704).

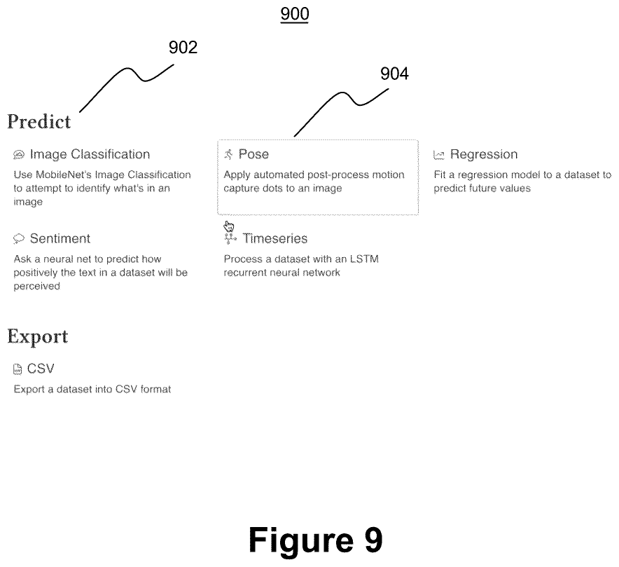

FIG. 9 illustrates selection of a fourth module from a fourth category in accordance with various embodiments. In FIG. 9, an interface 900 may be caused to be displayed responsive to the indication of a selection of the +sign 808 shown in FIG. 8. The interface 900 may be similar to the interface 300 shown in FIG. 3, interface 500 shown in FIG. 5, and interface 700 shown in FIG. 7. Accordingly, the interface 900 may include a number of categories 902 and a number of modules 904. Shown in FIG. 9, a module from a Predict category may be selected. As shown, a Regression module 904 may be selected. The Regression module 704 may be configured to fit a regression model to a dataset to predict future values.

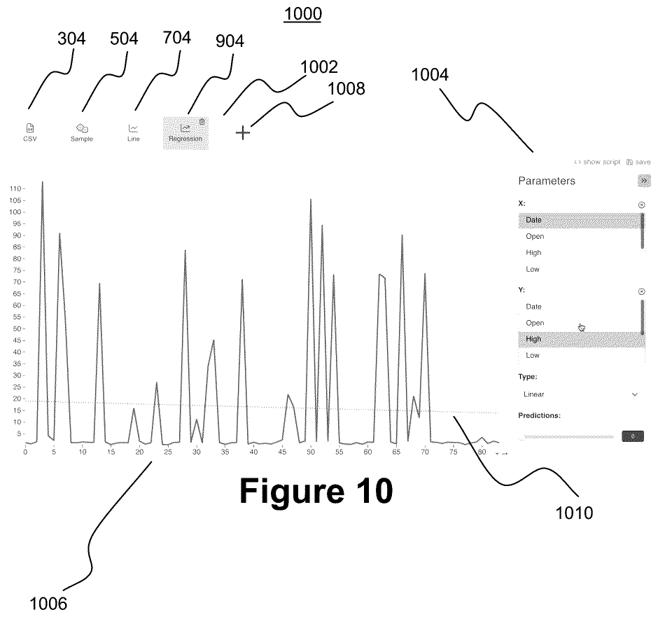

FIG. 10 illustrates an interface configured to display a third module in accordance with various embodiments. In FIG. 10, an interface 1000 may be displayed subsequent to the selection of the Regression module 904 in FIG. 9. Similar to the interface 400 shown in FIG. 4, interface 600 shown in FIG. 6, and interface 800, the interface 1000 may include a pipeline 1002, a parameter 1004, a visual result 1006, and a + sign 1008.

In FIG. 10, the interface 1000 may include the pipeline 1002 displaying the first module (e.g., CSV module 304), the selected second module (e.g., Sample module 504), the third module (e.g., Line module 704), and the selected third module (Regression module 904). Additionally, the interface 1000 may include the parameter 1004 displaying additional modifiable parameters corresponding to the modules in the pipeline (e.g., CSV module 304, Sample module 504, Line module 704, Regression module 904). For example, the parameter 1004 may display various parameters that may correspond to parameters for each of the modules in the pipeline 1002. As shown in FIG. 10, the visual result 1006 may display a line graph including a trend and prediction line 1010 because the selected modules may be related to datasets, which may be integrated to be visualized as the line graph and learned trends and predictions (e.g., selected Line module 704 and selected Regression module 904).

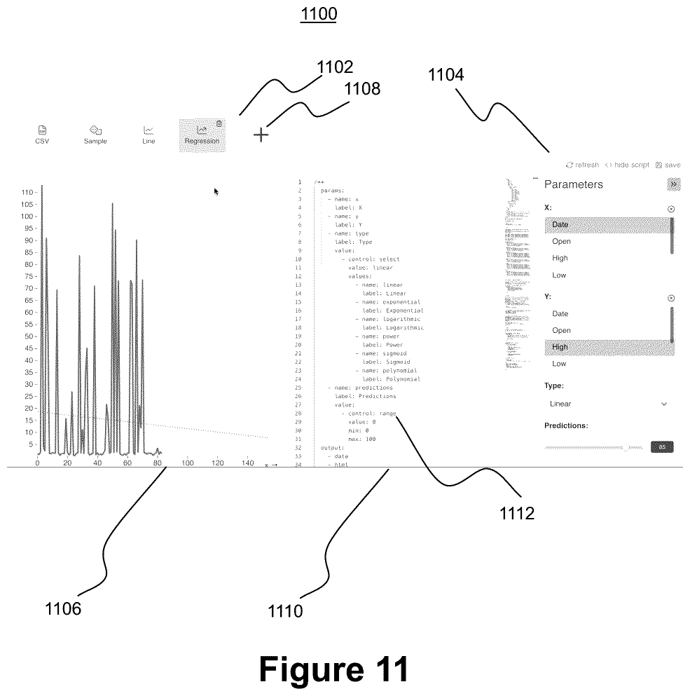

FIG. 11 illustrates code corresponding to one or more modules in accordance with various embodiments. In FIG. 11, an interface 1100 may include a pipeline 1102, a parameter 1104, a visual result 1106, and a + sign 1108 similar to the previous described interfaces. Shown in FIG. 11, the interface 1100 may include a fourth portion 1110, where the fourth portion 1110 may be configured to display code 1112 corresponding to the one or more modules included in the pipeline 1102. The code 1112 may be editable. For example, the parameter 1104 may include x axis and y axis corresponding to the Line module. However, the user may edit the code 1112 corresponding to the Line module to add a z axis.

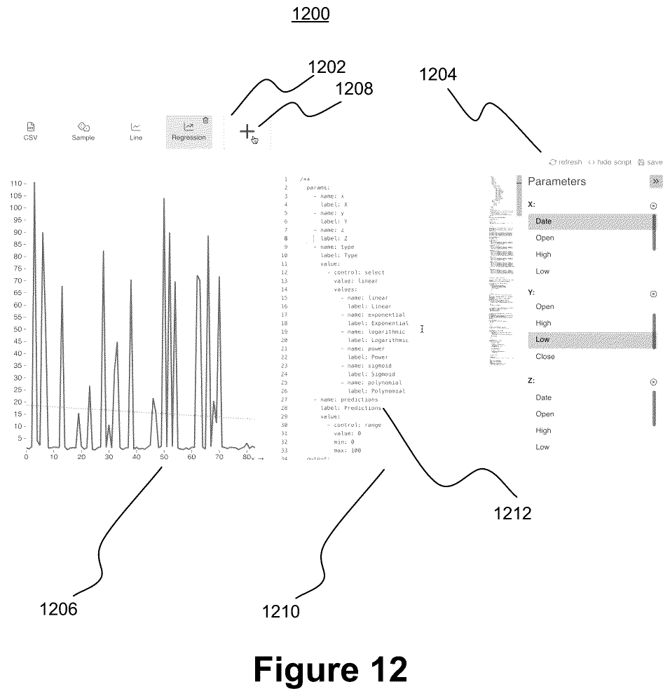

FIG. 12 illustrates edited code in accordance with various embodiments. In FIG. 12, an interface 1200 may include a pipeline 1202, a parameter 1204, a visual result 1206, and a + sign 1208 similar to the previous described interfaces. Shown in FIG. 12, the interface 1200 may include a fourth portion 1210, where the fourth portion 1210 may be configured to display code 1212 corresponding to the one or more modules included in the pipeline 1202. As previously described, the code 1212 may be editable, where a z axis may have been entered into the code corresponding to the Line module. Accordingly, the parameter 1204 may reflect the edits by modifying the parameter to include x axis, y axis, and the z axis. The visual result 1206 may change due to the effects of the edits to the code 1212 (i.e., addition of adding the z axis). In addition to the edits to the code 1212, changes to the pipeline 1202 (i.e., add and/or remove modules), the effects of the changes may be reflected in the visual result 1206 including any effects on the learned trends and/or predictions. As a result, a modular process may be provided via a user interface to facilitate machine learning in accordance with various embodiments.

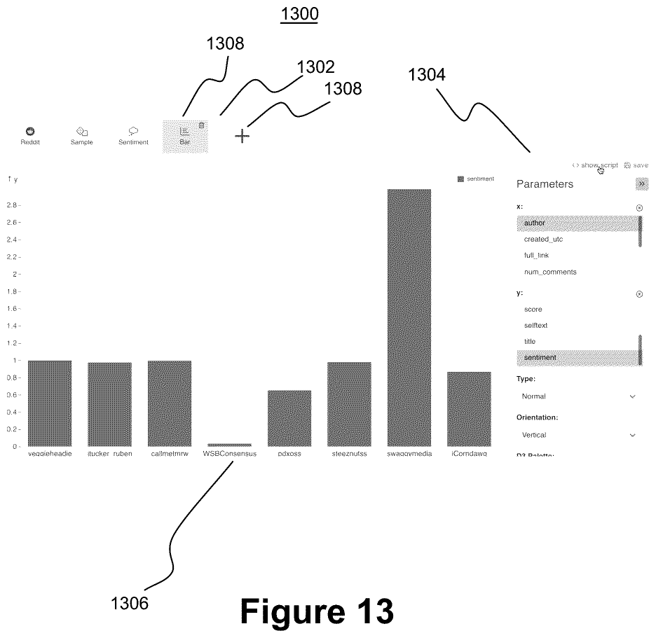

FIG. 13 illustrates an example of an interface in accordance with some alternate embodiments. In FIG. 13, an interface 1300 may include a pipeline 1302, a parameter 1304, a visual result 1306, and a + sign 1308 similar to the previous described interfaces. However, in FIG. 13, the pipeline 1302 may include a Bar graph module 1308. Accordingly, the visual result 1306 may be in the form of a bar graph as shown.

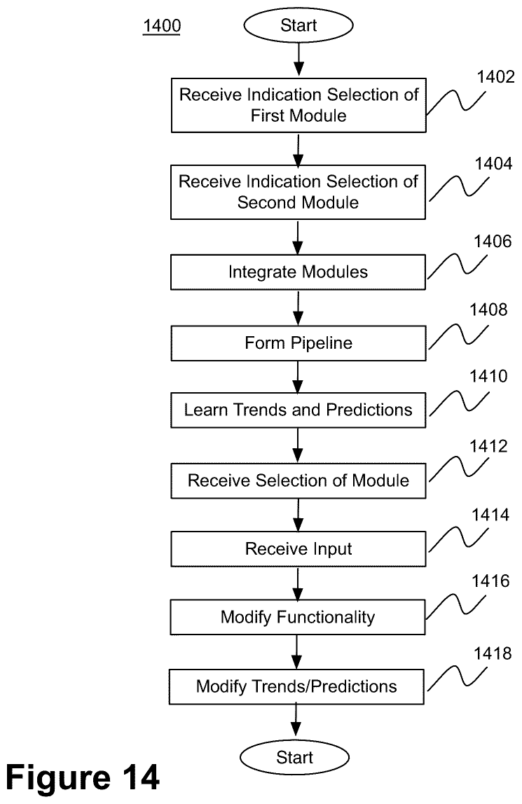

FIG. 14 illustrates an operational flow a modular AI process provided via a user interface to facilitate machine learning in accordance with various embodiments as described herein. In some portions of the description, illustrative implementations of the method are described with reference to the elements depicted in FIG. 1. However, the described embodiments are not limited to these depictions.

Additionally, FIG. 14 employs block diagrams to illustrate the example methods detailed therein. These block diagrams may set out various functional block or actions that may be described as processing steps, functional operations, events and/or acts, etc., and may be performed by hardware, software, and/or firmware. Numerous alternatives to the functional blocks detailed may be practiced in various implementations. For example, intervening actions not shown in the figures and/or additional actions not shown in the figures may be employed and/or some of the actions shown in one figure may be operated using techniques discussed with respect to another figure. Additionally, in some examples, the actions shown in these figures may be operated using parallel processing techniques. The above described, and other not described, rearrangements, substitutions, changes, modifications, etc., may be made without departing from the scope of the claimed subject matter.

In some examples, operational flow 1400 may be employed as part of an AI machine having learning capabilities. Beginning at block 1402 (“Receive Indication Selection of First Module”), an artificial intelligence configuration module (AICM) may be configured to receive an indication of selection of a first module, where the first module may be selectable from a first category.

Continuing from block 1402 to block 1404 (“Receive Indication Selection of Second Module”), the AICM may be configured to receive an indication of selection of a second module, where the second module may be selectable from a second category.

Continuing from block 1404 to block 1406 (“Integrate Modules”), the AICM may be configured to integrate the modules. The integration may be based upon first and second categories (i.e., the categories the modules may have been selected from).

Continuing from block 1406 to block 1408 (“Form Pipeline”), the AICM may be configured to form a pipeline having the integrated modules. The pipeline may be modifiable and be responsive to changes to the first and the second modules included in the pipeline.

Continuing from block 1408 to block 1410 (“Learn Trends and Predictions”), the AICM may be configured to learn treads and predictions based upon the integrated first module and the second module (i.e., the modules in the pipeline).

Continuing from block 1410 to block 1412 (“Receive Selection of Module”), the AICM may be configured to receive a selection of one of the first or the second module included in the pipeline.

Continuing from block 1412 to block 1414 (“Receive Input”), the AICM may be configured to receive an input to modify the code of the selected module included in the pipeline.

Continuing from block 1414 to block 1416 (“Modify Functionality”), the AICM may be configured to responsive to the received input, cause a modification of a functionality of the selected module resulting in a modified module, where the modified module may be a different version of the selected module included in the pipeline.

Continuing from block 1416 to block 1418 (“Modify Trends/Predictions”), the AICM may be configured to cause a modification of the learned trends and/or predictions based upon the modified module.

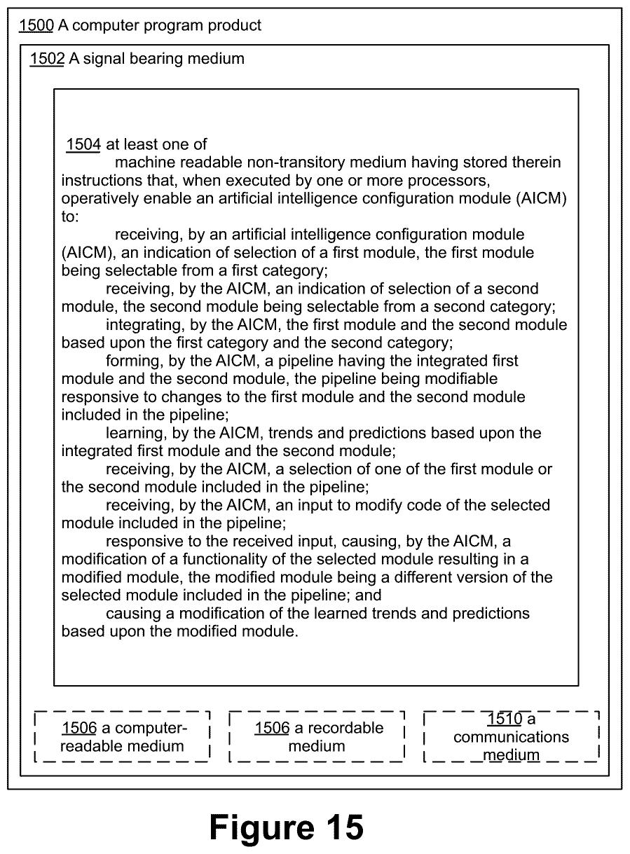

In general, the operational flow described with respect to FIG. 14 and elsewhere herein may be implemented as a computer program product, executable on any suitable computing system, or the like. For example, a computer program product for modular artificial intelligence may be provided. Example computer program products may be described with respect to FIG. 15 and elsewhere herein.

FIG. 15 illustrates an example computer program product 1500, arranged in accordance with at least some embodiments described herein. Computer program product 1500 may include machine readable non-transitory medium having stored therein instructions that, when executed, cause the machine to facilitate modular artificial intelligence according to the processes and methods discussed herein. Computer program product 1500 may include a signal bearing medium 1502. Signal bearing medium 1502 may include one or more machine-readable instructions 1504 which, when executed by one or more processors, may operatively enable a computing device to provide the functionality described herein. In various examples, the devices discussed herein may use some or all of the machine-readable instructions. In some examples, the machine readable instructions 1504 may include an artificial intelligence configuration module (AICM) configured to receive an indication of selection of a first module, where the first module being selectable from a first category. In some examples, the AICM may be configured to receive an indication of selection of a second module, where the second module being selectable from a second category. In some examples, the AICM may be configured to integrate the first module and the second module based upon the first category and the second category. In some examples, the AICM may be configured to form a pipeline having the integrated first module and the second module, where the pipeline being modifiable responsive to changes to the first module and the second module included in the pipeline. In some examples, the AICM may be configured to learn trends and predictions based upon the integrated first module and the second module. In some examples, the AICM may be configured to receive a selection of one of the first module or the second module included in the pipeline. In some examples, where the AICM may be configured to receive an input to modify code of the selected module included in the pipeline. In some examples, the AICM may be configured to responsive to the received input, cause a modification of a functionality of the selected module resulting in a modified module, where the modified module being a different version of the selected module included in the pipeline. In some examples, the AICM may be configured to cause a modification of the learned trends and predictions based upon the modified module.

In some implementations, signal bearing medium 1502 may encompass a computer-readable medium 1506, such as, but not limited to, a hard disk drive, a Compact Disc (CD), a Digital Versatile Disk (DVD), a Universal Serial Bus (USB) drive, a digital tape, memory, etc. In some implementations, the signal bearing medium 1502 may encompass a recordable medium 1508, such as, but not limited to, memory, read/write (R/W) CDs, R/W DVDs, etc. In some implementations, the signal bearing medium 1502 may encompass a communications medium 1510, such as, but not limited to, a digital and/or an analog communication medium (e.g., a fiber optic cable, a waveguide, a wired communication link, a wireless communication link, etc.). In some examples, the signal bearing medium 1502 may encompass a machine readable non-transitory medium.

In general, the methods described with respect to FIG. 14 and elsewhere herein may be implemented in any suitable computing system. Example systems may be described with respect to FIG. 16 and elsewhere herein. In general, the system may be configured to facilitate a modular artificial intelligence in accordance with various embodiments.

FIG. 16 is a block diagram illustrating an example computing device 1600, such as might be embodied by a person skilled in the art, which is arranged in accordance with at least some embodiments of the present disclosure. In one example configuration, computing device 1600 may include one or more processors 1610 and system memory 1620. A memory bus 1630 may be used for communicating between the processor 1610 and the system memory 1620.

Depending on the desired configuration, processor 1610 may be of any type including but not limited to a microprocessor (UP), a microcontroller (μC), a digital signal processor (DSP), or any combination thereof. Processor 1610 may include one or more levels of caching, such as a level one cache 1611 and a level two cache 1612, a processor core 1613, and registers 1614. The processor core 1613 may include an arithmetic logic unit (ALU), a floating point unit (FPU), a digital signal processing core (DSP Core), or any combination thereof. A memory controller 1615 may also be used with the processor 1610, or in some implementations the memory controller 1615 may be an internal part of the processor 1610.

Depending on the desired configuration, the system memory 1620 may be of any type including but not limited to volatile memory (such as RAM), non-volatile memory (such as ROM, flash memory, etc.) or any combination thereof. System memory 1620 may include an operating system 1621, one or more applications 1622, and program data 1624. Application 1622 may include modular artificial intelligence algorithm 1623 that is arranged to perform the functions as described herein including the functional blocks and/or actions described. Program Data 1624 may include, among other information described category and module data 1625 for use with the modular artificial intelligence algorithm 1623. In some example embodiments, application 1622 may be arranged to operate with program data 1624 on an operating system 1621 such that implementations of artificial intelligence configuration module (AICM) having modular artificial intelligence configuration capabilities may be provided as described herein. For example, apparatus described in the present disclosure may comprise all or a portion of computing device 1600 and be capable of performing all or a portion of application 1622 such that modular AI processes may be provided via to facilitate machine learning as described herein. This described basic configuration is illustrated in FIG. 16 by those components within dashed line 1601.

Computing device 1600 may have additional features or functionality, and additional interfaces to facilitate communications between the basic configuration 1601 and any required devices and interfaces. For example, a bus/interface controller 1640 may be used to facilitate communications between the basic configuration 1601 and one or more data storage devices 1650 via a storage interface bus 1641. The data storage devices 1650 may be removable storage devices 1651, non-removable storage devices 1652, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 1620, removable storage 1651 and non-removable storage 1652 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 1600. Any such computer storage media may be part of device 1600.

Computing device 1600 may also include an interface bus 1642 for facilitating communication from various interface devices (e.g., output interfaces, peripheral interfaces, and communication interfaces) to the basic configuration 1601 via the bus/interface controller 1640. Example output interfaces 1660 may include a graphics processing unit 1661 and an audio processing unit 1662, which may be configured to communicate to various external devices such as a display or speakers via one or more A/V ports 1663. Example peripheral interfaces 1660 may include a serial interface controller 1671 or a parallel interface controller 1672, which may be configured to communicate with external devices such as input devices (e.g., keyboard, mouse, pen, voice input device, touch input device, etc.) or other peripheral devices (e.g., printer, scanner, etc.) via one or more I/O ports 1673. An example communication interface 1680 includes a network controller 1681, which may be arranged to facilitate communications with one or more other computing devices 1690 over a network communication via one or more communication ports 1682. A communication connection is one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR) and other wireless media. The term computer readable media as used herein may include both storage media and communication media.

Computing device 1600 may be implemented as a portion of a small-form factor portable (or mobile) electronic device such as a cell phone, a personal data assistant (PDA), a personal media player device, a wireless web-watch device, a personal headset device, an application specific device, or a hybrid device that includes any of the above functions. Computing device 1600 may also be implemented as a personal computer including both laptop computer and non-laptop computer configurations. In addition, computing device 1600 may be implemented as part of a wireless base station or other wireless system or device.

It should be appreciated after review of this disclosure that it is contemplated within the scope and spirit of the present disclosure that the claimed subject matter may include a wide variety of computing environments. Accordingly, the claimed subject matter is not limited in these respects.

Some portions of the foregoing detailed description are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussion utilizing terms such as “processing,” “computing,” “calculating,” “determining” or the like refer to actions or processes of a computing device that manipulates or transforms data represented as physical electronic or magnetic quantities within memories, registers, or other information storage devices, transmission devices, or display devices of the computing device.

Claimed subject matter is not limited in scope to the particular implementations described herein. For example, some implementations may be in hardware, such as those employed to operate on a device or combination of devices, for example, whereas other implementations may be in software and/or firmware. Likewise, although claimed subject matter is not limited in scope in this respect, some implementations may include one or more articles, such as a signal bearing medium, a storage medium and/or storage media. This storage media, such as CD-ROMs, computer disks, flash memory, or the like, for example, may have instructions stored thereon that, when executed by a computing device such as a computing system, computing platform, or other system, for example, may result in execution of a processor in accordance with claimed subject matter, such as one of the implementations previously described, for example. As one possibility, a computing device may include one or more processing units or processors, one or more input/output devices, such as a display, a keyboard and/or a mouse, and one or more memories, such as static random access memory, dynamic random access memory, flash memory, and/or a hard drive.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be affected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skilled in the art in light of this disclosure. In addition, those skilled in the art will appreciate that the mechanisms of the subject matter described herein are capable of being distributed as a product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a flexible disk, a hard disk drive (HDD), a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and

B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Reference in the specification to “an implementation,” “one implementation,” “some implementations,” or “other implementations” may mean that a particular feature, structure, or characteristic described in connection with one or more implementations may be included in at least some implementations, but not necessarily in all implementations. The various appearances of “an implementation,” “one implementation,” or “some implementations” in the preceding description are not necessarily all referring to the same implementations.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter is not limited to the particular examples disclosed, but that such claimed subject matter also may include all implementations falling within the scope of the appended claims, and equivalents thereof.

What is claimed:

1. A system comprising:
a processor;
a storage medium, the storage medium communicatively coupled to the processor; and
an artificial intelligence configuration module (AICM) communicatively coupled to the storage medium and to the processor, the AICM configured to:
receive an indication of selection of a first module, the first module being selectable from a first category,
receive an indication of selection of a second module, the second module being selectable from a second category,
integrate the first module and the second module based upon the first category and the second category,
form a pipeline having the integrated first module and the second module, the pipeline being modifiable responsive to changes to the first module and the second module included in the pipeline and configured to learn trends and predictions based upon the integrated first module and the second module,
receive a selection of one of the first module or the second module included in the pipeline,
receive an input to modify code of the selected module,
responsive to the received input, cause a modification of a functionality of the selected module resulting in a modified module, the modified module being a different version of the selected module included in the pipeline, and
cause a modification of the learned trends and predictions based upon the modified module.

2. The system of claim 1 further comprising a display communicatively coupled to the AICM.

3. The system of claim 2, wherein the AICM comprises the AICM configured to receive the indication of selection of the first module and selection of the second module via a user interface.

4. The system of claim 2, wherein the AICM comprises the AICM configured to cause to display the first module and the second module as portions of a selectable user interface.

5. The system of claim 2, wherein the AICM comprises the AICM configured to cause to display the first module and the second module as selectable modules within the first category and the second category.

6. The system of claim 2, wherein the AICM comprises the AICM configured to cause to display the pipeline as a sequential pipeline having the graphical representations of the first module and the second module.

7. The system of claim 2, wherein the AICM comprises the AICM configured to cause to display code of the selected module on a portion of the display.

8. The system of claim 2, wherein the AICM comprises the AICM configured to cause to display on a user interface a first portion configured to receive the indication of selection of the first module and selection of the second module to display as the pipeline, a second portion configured to display the learned trends and predictions, a third portion configured to display adjustable parameters of the first and second modules, and a third portion configured to display editable code associated with the first module and the second module.

9. A method for machine learning of trends and predictions, the method comprising:
receiving, by an artificial intelligence configuration module (AICM), an indication of selection of a first module, the first module being selectable from a first category;
receiving, by the AICM, an indication of selection of a second module, the second module being selectable from a second category;
integrating, by the AICM, the first module and the second module based upon the first category and the second category;
forming, by the AICM, a pipeline having the integrated first module and the second module, the pipeline being modifiable responsive to changes to the first module and the second module included in the pipeline;
learning, by the AICM, trends and predictions based upon the integrated first module and the second module;
receiving, by the AICM, a selection of one of the first module or the second module included in the pipeline;
receiving, by the AICM, an input to modify code of the selected module included in the pipeline;
responsive to the received input, causing, by the AICM, a modification of a functionality of the selected module resulting in a modified module, the modified module being a different version of the selected module included in the pipeline; and
causing a modification of the learned trends and predictions based upon the modified module.

10. The method of claim 9, wherein receiving the indications of selection of the first module and the second module comprise receiving the indications via a graphical user interface (GUI).

11. The method of claim 9, wherein integrating the first module and the second module based comprises integrating the first module and the second module based upon the first category and the second category being functionally sequential to each other.

12. The method of claim 9, wherein forming the pipeline comprises causing to display a graphical representation of the pipeline as a portion of GUI.

13. The method of claim 9 further comprising causing, by the AICM, to display on a user interface a first portion having graphical representations of the first module and the second module, a second portion having a graphical representation of the pipeline, a third portion having a graphical representation of the learning trends and predictions, and a fourth portion having code of the first module and the second module.

14. A graphical user interface comprising:
a first portion, the first portion configured to receive a selection of one or more modules, the one or more modules being selectable from one or more categories and to cause to display the one or more modules as a pipeline having the one or more modules arranged in a sequential order based upon the one or more categories;
a second portion, the second portion configured to display learned trends and predictions based on the pipeline;
a third portion, the third portion configured to display one or more parameters corresponding to the one or more modules included in the pipeline, the one or more parameters configured to be graphically adjustable; and
a fourth portion, the fourth portion configured to display code corresponding to the one or more modules, the code being editable to cause changes to the learned trends and predictions based upon the edits to the code.
